(19) United States
(12) Patent Application Publication
(10) Pub. No.: US 2025/0034033 A1
(43) Pub. Date: Jan. 30, 2025

(54) Compositions for Etching Glass and Methods of Etching Glass Using the Compositions

(71) Applicant: Vitro Flat Glass LLC, Cheswick, PA (US)

(72) Inventors: Jose Luis Tavares Cortes, Apodaca (MX); Arturo Si Ming Lamshing Tai, Monterrey (MX); Ana Gabriela Hernandez Mendoza, Garcia (MX)

(21) Appl. No.: 18/779,901

(22) Filed: Jul. 22, 2024

Related U.S. Application Data
(60) Provisional application No. 63/515,175, filed on Jul. 24, 2023.

(51) Int. Cl. C03C 15/00

(52) U.S. Cl. CPC C03C 15/00

(57) ABSTRACT

A method for acid etching glass comprising applying an etching composition over at least one of the first side and second side of a glass substrate for a period of time, and washing the glass substrate, wherein, based on a total weight of the composition, the composition comprises greater than 30 weight % of a bifluoride, at least 25 weight % of an inert filler, less than 30 weight % of a sugar alcohol, less than 10 weight % a thickener, less than 5 weight % of organic solvent; and at least 20 weight % water.

### CROSS-REFERENCE TO RELATED APPLICATION

The present application is related to U.S. Provisional Patent Application No. 63/515,175 filed Jul. 24, 2023, the disclosure of which is hereby incorporated by reference in its entirety.

### BACKGROUND OF THE INVENTION

### Field of the Invention

The invention relates to a method of chemically etching glass for producing etched glass with desired spectral properties, as well as a composition for etching glass and glass manufactured according to the method thereof.

### Description of Related Art

Acid etching is a process that involves a chemical mechanism known as nucleation, which leads to formation of crystals. For instance, when acid is applied to glass sheets, the acid reacts with the silicon of glass sheets. By having glass sheets react with acids on certain areas of the glass sheets, the glass sheets no longer have a flat or smooth surface on the reacted areas, thereby forming a chemically etched surface.

Referring generally to the process of etching glass sheets, glass sheets are initially supplied and received in storage racks such that the glass sheets are not damaged or scratched. The glass sheets may be further processed, such as taped, to avoid contact between certain portions of the glass sheets with the etching solution. For example, the edges of the glass may be taped to prevent etching of the glass sheets around the edges. Etching solution may be applied on one side of the glass for a predetermined amount of time. In another instance, when both sides of the glass are treated with etching solution, the entire glass sheet may be introduced into an etching solution bath. The glass may be washed with pressurized water as to void the glass of all interleaving powder, dust, and other contaminants.

After the predetermined amount of time, the glass is washed to remove any unwanted byproducts formed from the etching process, as well as any remaining etching solution from the glass. Then the glass may additionally be treated, such as by rinsing and drying. Then, the glass may be inspected to determine various features, such as the light transmittance of the treated glass.

The spectral properties of glass sheet sheets differ significantly depending on the etching solution used. Additionally, the spectral properties differ depending on whether the glass sheet was etched on just one side or both sides. Hence, etching solutions used for etching a glass sheet on one side is often not used for etching a glass sheet on both sides, as using the same etching solution would result in different spectral properties of the glass sheet. Different etching solutions are therefore typically used to provide similar spectral properties for glass sheets with one side etched and for glass sheets with both sides etched.

Accordingly, there is a need for an etching solution composition used for both one and two side etching processes that result in similar spectral properties.

### SUMMARY OF THE INVENTION

The invention relates to a method for etching glass comprising applying an etching composition over at least one of the first side and second side of a glass substrate for a period of time, and washing the glass substrate, wherein, based on a total weight of the composition, the composition comprises: greater than 30 weight % of a bifluoride, at least 25 weight % of an inert filler, less than 30 weight % of a sugar alcohol, less than 10 weight % a thickener, less than 5 weight % of organic solvent; and at least 20 weight % water.

The invention also relates to an etching composition, wherein the bifluoride comprises ammonium bifluoride, wherein the inert filler comprises barium sulfate, wherein the sugar alcohol comprises sorbitol, wherein the thickener comprises sodium bentonite. The composition may comprise less than 3 weight % of organic solvent, wherein the etching composition is only applied over the first side or the second side of the glass substrate, wherein the etching composition is applied over the first side and the second side of the glass substrate. The composition may comprise greater than 35 weight % of ammonium bifluoride, greater than 30 weight % of barium sulfate, less than or equal to 25 weight % of sorbitol, and less than 5 weight % of sodium bentonite.

The composition may comprise: an amount of from 35 to 45 weight % of ammonium bifluoride, an amount of from 35 to 45 weight % barium sulfate, an amount of from 15 to 25 weight % sorbitol, an amount of from 0.5 to 5 weight % sodium bentonite, an amount of from 20 to 40 weight % water, and less than 1 weight % of organic solvent, wherein an amount of the ammonium bifluoride is greater than amount of the sodium bentonite, wherein the composition consists of the ammonium bifluoride, the barium sulfate, the sorbitol, and the sodium bentonite.

The invention also may relate to a glass substrate, wherein the glass substrate is an architectural glass substrate. A glass substrate may be formed from the method discussed above, wherein only the first side of the glass substrate is etched with the etching composition. The glass substrate may exhibit a specular light transmittance within a range of 20 to 40%, a Sa roughness within a range of from 0.5 to 4 μm, a Sq roughness within a range of from 0.5 to 4 μm, a Sz roughness within a range of from 30 to 50 μm, a 20° gloss of from 0 to 5 gloss units, a 60° gloss of from 0 to 5 gloss units, and a 85° gloss of from 0 to 10 gloss units. The first side and the second side of the glass substrate may be etched with the etching composition. The glass substrate may exhibit a specular light transmittance within a range of 20 to 40%, a Sa roughness within a range of from 2 to 6 μm, a Sq roughness within a range of from 2 to 6 μm, a Sz roughness within a range of from 50 to 70 μm, a 20° gloss of from 0 to 5 gloss units, a 60° gloss of from 0 to 10 gloss units, and a 85° gloss of from 5 to 15 gloss units. The first side and the second side of the glass substrate may be etched with the etching composition and the glass substrate is a non-glare glass substrate. The glass substrate may exhibit a specular light transmittance within a range of 70 to 90%, a Sa roughness within a range of from 0.5 to 4 μm, a Sq roughness within a range of from 0.5 to 4 μm, a Sz roughness within a range of from 30 to 50 μm, a 20° gloss of from 0 to 5 gloss units, a 600 gloss of from 0 to 20 gloss units, and a 85° gloss of from 0 to 15 gloss units.

Also, the invention may relate to an acid etching composition comprising: from 35 to 45 weight % of a bifluoride, from 35 to 45 weight % of an inert filler, from 15 to 25 weight % of a sugar alcohol, from 0.5 to 5 weight % of a thickener, less than 5 weight % organic solvent, and at least 20 weight % water, wherein the bifluoride comprises ammonium bifluoride, wherein the inert filler comprises barium sulfate, wherein the thickener comprises sodium bentonite, wherein the composition comprises less than 3 weight % of organic solvent, wherein the composition is completely free of organic solvent, wherein the composition consists of the ammonium bifluoride, the barium sulfate, the sorbitol, the sodium bentonite, and water.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques.

Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like.

The terms “visible region”, “visible light”, or “visible light spectrum” refer to electromagnetic radiation having a wavelength in the range of 380 nm to 800 nm. The terms “infrared region”, “infrared radiation”, or “infrared spectrum” refer to electromagnetic radiation having a wavelength in the range of greater than 800 nm to 100,000 nm. The terms “ultraviolet region”, “ultraviolet radiation”, or “ultraviolet (UV) spectrum” mean electromagnetic energy having a wavelength in the range of 300 nm to less than 380 nm.

Weight percentages (wt. %) of the components of the etching composition, as used herein, are based on the total weight of the etching composition.

The present disclosure includes a method of etching a glass substrate. The glass substrate may comprise, for example, clear float glass or can be tinted or colored glass. The glass substrate can be of any desired dimensions, e.g., length, width, shape, or thickness. In one non-limiting embodiment, the glass substrate may be an architectural glass substrate. For example, the glass substrate may have an architectural transparency. The term “architectural transparency” refers to any transparency located on a building, such as, but not limited to, windows and sky lights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles, as well as personal transparency such as glasses and the like.

The glass substrate may be 1 mm to 30 mm thick, such as 2.5 mm to 25 mm thick, such as 2.5 mm to 10 mm thick. Additionally, while a typical transparency can have sufficient visible light transmission such that materials can be viewed through the transparency, in the practice of the invention, the transparency need not be transparent to visible light but may be translucent or opaque.

In one example, only one side of the glass substrate may be etched. Before applying an etching composition to one side of the glass substrate, the glass substrate may be further processed, such as taped, to prevent the etching composition from contacting the glass substrate. The etching composition may be applied on the glass surface for a predetermined amount of time. The etching composition may be applied on the glass for a specific amount of time, for example 1 to 10 minutes, 1 to 8 minutes, 2 to 6 minutes, 2 to 5 minutes, and 3 to 4 minutes. The etching composition may be applied evenly by aspersion. After a predetermined amount of time, the glass substrate may be rinsed with pressurized water to remove all interleaving powder, dust, and any other contaminants.

In another example, both sides of the glass substrate may be etched. To etch both sides of the glass substrate, the glass substrate may be treated via immersion. The glass substrate may be immersed in numerous different chemical solutions in a predetermined sequence. For instance, the glass substrate may be immersed in a hydrochloric acid solution, rinsed with water, immersed in an etching composition, rinsed with water, immersed in a sulfuric acid solution, and rinsed with water. In another example, the glass substrate may further be immersed in hydrofluoric acid solution and rinsed with water for creating non-glare glass substrates. The hydrochloric acid solution may include HCl in the range of 20-50 weight %, such as 25-45 weight %, or such as, 30-40 weight %. The sulfuric acid may include H₂SO₄ in the range of, 1 to 30 weight %, such as 5 to 25 weight %, or such as 10 to 20 weight %. The hydrofluoric acid may include HF in the range of 30-70 weight %, such as 40-60 weight %, or such as 45-55 weight %. The glass substrate may be immersed in each of the different solutions for any predetermined amount of time. For example, the glass substrate may be treated for 1 to 10 minutes, such as 1 to 8 minutes, such as 2 to 6 minutes, such as 2 to 5 minutes, or such as 3 to 4 minutes.

The etching composition can also be applied while stirring the composition. In other examples, the etching composition can be applied without stirring the composition.

The preset disclosure is also directed to an etching composition for treating the glass substrate and which can be used in any of the previously described methods. The etching composition may be a liquid solution.

The etching composition may comprise a bifluoride component. For example, the etching composition may comprise ammonium bifluoride, or NH₄HF₂ and/or sodium bifluoride. The etching composition may comprise greater than 30 weight % of a bifluoride, such as at least 35 weight % of a bifluoride, based on the total weight of the etching composition. The composition solution can also comprise up to 60 weight %, such as up to 50 weight % or up to 45 weight %, based on the total weight of the etching composition. The etching composition can also comprise a bifluoride within a range of, 30-60 weight %, or such as 35-50 weight %, such as 35-45 weight %, or such as 38-42 weight %, based on the total weight of the etching composition.

The etching composition may also comprise an inert filler. An “inert filler”, as used herein, refers to a suitable material for an etching composition that does not cause or promote a change to the chemical properties of the final etching composition. For example, the inert filler may be barium sulfate (BaSO₄), modified acidified starch, modified dextrin, and the like. The composition may comprise one or more inert fillers. The etching composition may comprise an inert filler in an amount of at least 25 weight %, such as at least 30 weight %, based on the total weight of the etching composition. The etching composition can also comprise up to 50 weight % of the inert filler, such as up to 45 weight %, based on the total weight of the etching composition. The etching composition can also comprise an inert filler within a range of from 25-50 weight %, such as 30-50 weight %, such as 35-45 weight %, or such as 36-40 weight %, based on the total weight of the etching composition.

The etching composition may further comprise a sugar alcohol. The sugar alcohol can include sorbitol, or C₆H₁₄O₆. Sorbitol may be used at various concentration. For example, sorbitol having a concentration in the range of 50-100 weight %, such as 60-90 weight %, or such as 65-75 weight % may be used. The etching composition may comprise less than 30 weight % of sorbitol, such as less than 25 weight % sorbitol, based on the total weight of the etching composition. The etching composition can also comprise at least 5 weight % of sorbitol, such as at least 10 weight % or at least 15 weight %, based on the total weight of the etching composition. The etching composition can also comprise sorbitol within a range of 5 to less than 30 weight %, such as 15-25 weight % or such as 18-22 weight %, based on the total weight of the etching composition. The etching composition may comprise sorbitol, but may also be free of any other organic solvents as explained in further detail herein.

The etching composition may additionally comprise a thickener. As used herein, a “thickener” refers to a material that increases the viscosity of the etching composition. The thickener may be any suitable material, for example sodium bentonite, cellulose gums such as hydroxyl ethyl, carboxymethyl and polysaccharides gum such as xanthan gum, tragacanth gum, and acacia gum, polyurethane associative thickener, rheology modifier, and film forming associative thickener such as modified organoclay modified smectite clay bentonite clay, hectorite clay, and the like that increases the viscosity of the etching composition as desired without effecting the other desirable properties of the etching composition. The etching composition may comprise one or more thickeners. The etching composition may comprise at least 0.5 weight % of a thickener (e.g., sodium bentonite), such as at least 1 weight %, based on the total weight of the etching composition. The etching composition can also comprise less than 10 weight % of a thickener, such as up to 5 weight %, based on the total weigh of the thickener. The etching composition can also comprise a thickener within a range of 0.5 to less than 10 weight %, such as 0.5-5 weight %, or such as 1-4 weight %, based on the total weight of the etching composition.

The etching composition may further comprise water. The etching composition may comprise at least 20 weight % water, such as at least 25 weight %, based on the total weight of the etching composition. The etching composition can also comprise up to 50 weight %, such as up to 40 weight %, based on the total weight of the etching composition. The etching composition can also comprise water within a range of 20-50 weight %, such as 20-45 weight %, or such as 20-40 weight %, based on the total weight of the etching composition.

The etching composition can also be free of various materials. That is, the etching composition can be free of sulfamic acid, or SO₃NH₃, or contain a low amount of sulfamic acid. For example, the etching composition may contain less than 5 weight %, such as less than 3 weight %, or such as less than 1 weight % sulfamic acid. Alternatively, the etching composition may be completely free of sulfamic acid.

The etching composition may also be free of, or contain low amounts, of any other organic solvent. An “organic solvent”, as used herein, refers to any carbon-based substance capable of dissolving or dispersing any of the substances in the etching composition. For example, organic solvent may comprise glycols and glycol ethers such as propylene glycol, propylene glycol mono methyl ether acetate, propylene glycol mono methyl ether, propylene glycol phenyl ether, propylene glycol mono propyl ether, ethylene glycol butyl ether, diethylene glycol butyl ether, etc. The etching composition can be free of organic solvent, or can contain a low amount of organic solvent. For example, the etching composition may contain less than 5 weight %, such as less than 3 weight %, or such as less than 1 weight % of organic solvent. Alternatively, the etching composition may be completely free of organic solvent.

The etching composition may also be free of, or contain low amounts, of potassium feldspar. For example, the etching composition may contain less than 5 weight %, such as less than 3 weight %, or such as less than 1 weight % of potassium feldspar. Alternatively, the etching composition may be completely free of potassium feldspar.

The etching composition may also be free of, or contain low amounts, of hydrochloric acid or HCl. For example, the etching composition may contain less than 5 weight %, such as less than 3 weight %, or such as less than 1 weight % of HCl. Alternatively, the etching composition may be completely free of HCl.

The previously described etching composition can also be limited to only include (i.e., consist of) certain components. For example, the etching composition can also be limited to only including the previously described bifluoride, inert filler, sugar alcohol, thickener, water, and optionally low amounts of organic solvent. Alternatively, the etching composition is free of organic solvent.

The invention is also directed to a glass substrate that has been etched with the above discussed etching composition having certain spectral properties. For instance, the glass substrate which has been treated with the etching composition on one side or immersed to treat both sides may have a specular light transmittance % value in the range of 5-60%, such as 10-50%, or such as 20-40%. The glass substrate, which has been treated and both sides and further processed with HF to create non-glare glass substrate, may have specular light transmittance % value in the range of, for example, 50-100%, 60-95%, or 70-90%. The light transmittance was determined using ETMD Window Energy Meter Model WE2500.

The glass substrate, which has been etched on only one side, may exhibit a particular roughness. For example, the glass substrate may have Sa roughness, measured in μm, in the range of 0.1-10, 0.1-7, and 0.5-4. The glass substrate may have a Sq roughness, measured in μm, in the range of 0.1-10, 0.1-7, and 0.5-4. The glass substrate may have a Sz roughness, measured in μm in the range of 10-70, 20-60, or 30-50. Surface roughness was determined using a Filmetrics Profilm3D with 20× Mirau objective and Nano30 vibration isolation stage.

The glass substrate, which has been etched on both sides, may exhibit a particular roughness. For example, the glass substrate may have a Sa roughness, measured in μm, in the range of less than 10, 1-7, and 2-6. The glass substrate may have a Sq roughness, measured in μm, in the range of less than 10, 1-7, and 2-6. The glass substrate may have a Sz roughness, measure in μm, in the range of 30-90, 40-80, and 50-70. Surface roughness was determined using a Filmetrics Profilm3D with 20× Mirau objective and Nano30 vibration isolation stage.

The glass substrate, which has been etched on both sides, as well as hydrofluoric acid, may exhibit particular roughness characteristics. For example, the glass substrate may have Sa roughness, measured in μm, in the range of 0.1-10, 0.1-7, and 0.5-4. The glass substrate may have a Sq roughness, measured in μm, in the range of 0.1-10, 0.1-7, and 0.5-4. The glass substrate may have a Sz roughness, measured in μm in the range of 10-70, 20-60, or 30-50. Surface roughness was determined using a Filmetrics Profilm3D with 20× Mirau objective and Nano30 vibration isolation stage.

The glass substrate, which has been etched only on onside, may exhibit particular gloss characteristics. For example, the glass substrate may exhibit high gloss at the angle of 20°, measured in GU, in the range of 0-10, such as, 0-7, or such as 0-5. The glass substrate may exhibit medium gloss at the angle of 60°, measured in GU, in the range of 0-10, such as 0-7, or such as 0-5. The glass substrate may exhibit low gloss at the angle of 85°, measured in GU, in the range of 0-20, such as 0-15, or such as 0-10. The gloss measurements were made using J408-268 ELCOMETER 408 GLOSS & DOI METER TRIPLE ANGLE 20, 60 & 85 degree.

The glass substrate, which has been etched on both sides, may exhibit particular gloss characteristics. For example, the glass substrate may exhibit high gloss at the angle of 20°, measured in GU, in the range of 0-10, such as, 0-7, or such as 0-5. The glass substrate may exhibit medium gloss at the angle of 60°, measured in GU, in the range of 0-20, such as 0-15, or such as 0-10. The glass substrate may exhibit low gloss at the angle of 85°, measured in GU, in the range of 0-20, such as 2-18, or such as 5-15. The gloss measurements were made using J408-268 ELCOMETER 408 GLOSS & DOI METER TRIPLE ANGLE 20, 60 & 85 degree.

The glass substrate, which has been etched on both sides, as well as treated with as hydrofluoric acid, may exhibit particular gloss characteristics. For example, the glass substrate may exhibit high gloss at the angle of 20°, measured in GU, in the range of 0-10, such as, 0-7, or such as 0-5. The glass substrate may exhibit medium gloss at the angle of 60°, measured in GU, in the range of 0-40, such as 0-30, or such as 0-20. The glass substrate may exhibit low gloss at the angle of 85°, measured in GU, in the range of 0-20, such as 0-18, or such as 0-15. The gloss measurements were made using J408-268 ELCOMETER 408 GLOSS & DOI METER TRIPLE ANGLE 20, 60 & 85 degree.

The glass etching composition in accordance with the present disclosure can also exhibit a particular viscosity. For instance, the glass etching composition can comprise a viscosity from 10-15 seconds using a ford cup #4 or from 20-30 centipoises.

The invention is further described in the following numbered clauses:

Clause 1: A method for acid etching glass comprising: applying an etching composition over at least one of the first side and second side of a glass substrate for a period of time, and washing the glass substrate, wherein, based on a total weight of the composition, the composition comprises: greater than 30 weight % of a bifluoride, at least 25 weight % of an inert filler, less than 30 weight % of a sugar alcohol, less than 10 weight % of a thickener, less than 5 weight % of organic solvent; and at least 20 weight % water.

Clause 2: The method of clause 1, wherein the bifluoride comprises ammonium bifluoride.

Clause 3: The method of clause 1 or 2, wherein the inert filler comprises barium sulfate.

Clause 4: The method of any of clauses 1-3, wherein the sugar alcohol comprises sorbitol.

Clause 5: The method of any of clauses 1-4, wherein the thickener comprises sodium bentonite.

Clause 6: The method of any of clauses 1-5, wherein the composition comprises less than 3 weight % of organic solvent.

Clause 7: The method of any of clauses 1-6, wherein the etching composition is only applied over the first side or the second side of the glass substrate.

Clause 8: The method of any of clauses 1-7, wherein the etching composition is applied over the first side and the second side of the glass substrate.

Clause 9: The method of any of clauses 1-8, wherein the composition comprises greater than 35 weight % of ammonium bifluoride.

Clause 10: The method of any of clauses 1-9, wherein the composition comprises greater than 30 weight % of barium sulfate.

Clause 11: The method of any of clauses 1-10, wherein the composition comprises less than or equal to 25 weight % of sorbitol.

Clause 12: The method of any of clauses 1-11, wherein the composition comprises less than 5 weight % of sodium bentonite.

Clause 13: The method of any of clauses 1-12, wherein the composition comprises: an amount of from 35 to 45 weight % of ammonium bifluoride, an amount of from 35 to 45 weight % barium sulfate, an amount of from 15 to 25 weight % sorbitol, an amount of from 0.5 to 5 weight % sodium bentonite, an amount of from 20 to 40 weight % water, and less than 1 weight % of organic solvent.

Clause 14: The method of any of clauses 1-13, wherein an amount of the ammonium bifluoride is greater than amount of the sodium bentonite.

Clause 15: The method of any of clauses 1-14, wherein the composition consists of the ammonium bifluoride, the barium sulfate, the sorbitol, and the sodium bentonite.

Clause 16: The method of any of clauses 1-15, wherein the glass substrate is an architectural glass substrate.

Clause 17: A glass substrate formed from the method according to clause 1.

Clause 18: The glass substrate of clause 17, wherein the glass substrate is an architectural glass substrate.

Clause 19: The glass substrate of clause 17 or 18, wherein only the first side of the glass substrate is etched with the etching composition.

Clause 20: The glass substrate of any of clauses 17-19, wherein the glass substrate exhibits a specular light transmittance within a range of 20 to 40%, a Sa roughness within a range of from 0.5 to 4 μm, a Sq roughness within a range of from 0.5 to 4 μm, a Sz roughness within a range of from 30 to 50 μm, a 20° gloss of from 0 to 5 gloss units, a 60° gloss of from 0 to 5 gloss units, and a 85° gloss of from 0 to 10 gloss units.

Clause 21: The glass substrate of any of clauses 17-20, wherein the first side and the second side of the glass substrate are etched with the etching composition.

Clause 22: The glass substrate of any of clauses 17-21, wherein the glass substrate exhibits a specular light transmittance within a range of 20 to 40%, a Sa roughness within a range of from 2 to 6 μm, a Sq roughness within a range of from 2 to 6 μm, a Sz roughness within a range of from 50 to 70 μm, a 20° gloss of from 0 to 5 gloss units, a 60° gloss of from 0 to 10 gloss units, and a 85° gloss of from 5 to 15 gloss units.

Clause 23: The glass substrate of any of clauses 17-22, wherein the first side and the second side of the glass substrate are etched with the etching composition and the glass substrate is a non-glare glass substrate.

Clause 24: The glass substrate of any of clauses 17-23, wherein the glass substrate exhibits a specular light transmittance within a range of 70 to 90%, a Sa roughness within a range of from 0.5 to 4 μm, a Sq roughness within a range of from 0.5 to 4 μm, a Sz roughness within a range of from 30 to 50 μm, a 20° gloss of from 0 to 5 gloss units, a 60° gloss of from 0 to 20 gloss units, and a 85° gloss of from 0 to 15 gloss units.

Clause 25: An acid etching composition comprising: from 35 to 45 weight % of a bifluoride, from 35 to 45 weight % of an inert filler, from 15 to 25 weight % a sugar alcohol, from 0.5 to 5 weight % of a thickener, less than 5 weight % organic solvent, and at least 20 weight % water.

Clause 26: The method of clause 25, wherein the bifluoride comprises ammonium bifluoride.

Clause 27: The composition of clause 25 or 26, wherein the inert filler comprises barium sulfate.

Clause 28: The composition of any of clauses 25-27, wherein the sugar alcohol comprises sorbitol.

Clause 29: The composition of any of clauses 25-28, wherein the thickener comprises sodium bentonite.

Clause 30: The composition of any of clauses 25-29, wherein the composition comprises less than 3 weight % of organic solvent.

Clause 31: The composition of any of clauses 25-30, wherein the composition is completely free of organic solvent.

Clause 32: The composition of any of clauses 25-31, wherein the composition consists of the ammonium bifluoride, the barium sulfate, the sorbitol, the sodium bentonite, and water.

The following examples are presented to demonstrate the general principles of the invention. The invention should not be considered as limited to the specific examples presented. All parts and percentages in the examples are by weight unless otherwise indicated.

### Example 1

### Preparation of Glass Etching Solutions

Three glass etching compositions were prepared by mixing the materials shown in Table 1 to form three separate glass etching solutions.

TABLE 1

| | | Comparative | Comparative |
|---|---|---|---|
| Material | Composition 1 | Composition 2 | Composition 3 |
| Ammonium Bifluoride | 40% | 40% | 40% |
| Barium Sulphate | 38% | 40% | 30% |
| Sorbitol | 20% | 20% | 0% |
| Water | 35% | 35% | 35% |
| Bentonite | 2% | 0% | 0% |
| Dextrose monohydrate | 0% | 0% | 30% |

### Examples 2-6

Glass Etching with Different Glass Etching Solutions

The glass etching compositions of Example 1 were each independently applied to the surface of clear glass substrates at a temperature of 23° C. without stirring the solutions during the etching process. The etchings times, surface appearance, and light transmittance were of each clear glass substrate is detailed in Table 2.

TABLE 2

| | Etching | Etching | | Light |
|---|---|---|---|---|
| Example | Solution | Time | Surface Appearance | Transmittance¹ |
| Example 2 | Comparative | 3 minutes | Surface Not homogeneous. | 30% |
| | Composition 2 | | (Main defect: stripes/stains) | |
| Example 3 | Composition 1 | 3 minutes | Surface OK (homogeneous) | 28% |
| Example 4 | Composition 1 | 6 minutes | Surface Not homogeneous. | 14% |
| | | | (Main defect: stains) | |
| Example 5 | Comparative | 3 minutes | Surface Not homogeneous. | 52% |
| | Composition 3 | | (Main defect: stains) | |
| Example 6 | Comparative | 6 minutes | Surface Not homogeneous. | 52% |
| | Composition 3 | | (Main defect: stains) | |

¹The light transmittance was determined using ETMD Window Energy Meter Model WE2500.

As shown in Table 2, Example 2 used comparative composition 2 that did not contain bentonite (thickener) and the suspension was broken after some time leading to separation of components at a micro scale, which led to homogeneity issues during the etching.

Similarly, Examples 5 and 6 both used comparative composition 3 that does not contain sorbitol (alcohol sugar) and bentonite (thickener), but instead contained dextrose monohydrate. Further, the etching time in Example 5 was 3 minutes, while the etching time in Example 6 was 6 minutes. In both Examples 5 and 6, the glass surfaces were not homogenous and had stains. In addition, the light transmittance of Examples 5 and 6 was higher than desired.

Examples 3 and 4 utilized composition 1 in accordance with the present disclosure. The etching time in Example 3 was 3 minutes and provided a homogenous surface, as well as a desired light transmittance within a range of 20%-30%. In contrast, Example 4, which was etched at a longer period time, exhibited a surface that was not homogenous and had stains and which also a low light transmittance of 14%.

### Examples 7-8

Glass Etching with Glass Etching Composition 1

Glass etching composition 1 of Example 1 was again applied to the surface of clear glass substrates at a temperature of 23° C., but which was instead stirred during the etching process. The etchings times, surface appearance, and light transmittance were of each clear glass substrate is detailed in Table 3.

TABLE 3

| | Etching | Etching | | Light |
|---|---|---|---|---|
| Example | Solution | Time | Surface Appearance | Transmittance¹ |
| Example 7 | Composition 1 | 3 minutes | Surface OK (homogeneous) | 27% |
| Example 8 | Composition 1 | 6 minutes | Surface OK (homogeneous) | 19% |

As shown in Table 3, Examples 7 and 8 both exhibited a homogenous surface despite Example 8 having an etching time of 6 minutes. The light transmittance of Example 7 fell within a range of 20%-30% and the light transmittance of Example 7 was just below at 19%. As such, by stirring the composition during the etching process, the surface appearance and light transmittance improved.

### Example 9

### Surface Roughness Testing

Additional surface roughness data was also determined for Examples 2-4 and 7-8, which is shown in Table 4.

| Surface | | | | | |
|---|---|---|---|---|---|
| Roughness² | Example 2 | Example 3 | Example 4 | Example 7 | Example 8 |
| Sa | 2.762 | 2.808 | 2.954 | 2.997 | 2.76 |
| Sq | 3.481 | 3.582 | 3.766 | 3.798 | 3.511 |
| Sz | 39.62 | 40.46 | 40.75 | 39.63 | 40.36 |

²Surface roughness was determined by Filmetrics Profilm3D with 20x Mirau objective and Nano30 vibration isolation stage.

While the disclosure has been described as having exemplary designs, the present disclosure can be further modified within the spirit and scope of this disclosure. This application is, therefore, intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for acid etching glass comprising:
applying an etching composition over at least one of the first side and second side of a glass substrate for a period of time, and
washing the glass substrate,
wherein, based on a total weight of the composition, the composition comprises:
greater than 30 weight % of a bifluoride,
at least 25 weight % of an inert filler,
less than 30 weight % of a sugar alcohol,
less than 10 weight % a thickener,
less than 5 weight % of organic solvent; and
at least 20 weight % water.

2. The method of claim 1, wherein the bifluoride comprises ammonium bifluoride.

3. The method of claim 1, wherein the inert filler comprises barium sulfate.

4. The method of claim 1, wherein the sugar alcohol comprises sorbitol.

5. The method of claim 1, wherein the thickener comprises sodium bentonite.

6. The method of claim 1, wherein the composition comprises less than 3 weight % of organic solvent.

7. The method of claim 1, wherein the etching composition is only applied over the first side or the second side of the glass substrate.

8. The method of claim 1, wherein the etching composition is applied over the first side and the second side of the glass substrate.

9. The method of claim 2, wherein the composition comprises greater than 35 weight % of ammonium bifluoride.

10. The method of claim 3, wherein the composition comprises greater than 30 weight % of barium sulfate.

11. The method of claim 4, wherein the composition comprises less than or equal to 25 weight % of sorbitol.

12. The method of claim 5, wherein the composition comprises less than 5 weight % of sodium bentonite.

13. The method of claim 1, wherein the composition comprises:
an amount of from 35 to 45 weight % of ammonium bifluoride,
an amount of from 35 to 45 weight % barium sulfate,
an amount of from 15 to 25 weight % sorbitol,
an amount of from 0.5 to 5 weight % sodium bentonite,
an amount of from 20 to 40 weight % water, and
less than 1 weight % of organic solvent.

14. The method of claim 13, wherein an amount of the ammonium bifluoride is greater than amount of the sodium bentonite.

15. The method of claim 13, wherein the composition consists of the ammonium bifluoride, the barium sulfate, the sorbitol, and the sodium bentonite.

16. The method of claim 1, wherein the glass substrate is an architectural glass substrate.

17. A glass substrate formed from the method according to claim 1.

18. The glass substrate of claim 17, wherein the glass substrate exhibits a specular light transmittance within a range of 20 to 40%, a Sa roughness within a range of from 0.5 to 4 μm, a Sq roughness within a range of from 0.5 to 4 μm, a Sz roughness within a range of from 30 to 50 μm, a 20° gloss of from 0 to 5 gloss units, a 60° gloss of from 0 to 5 gloss units, and a 85° gloss of from 0 to 10 gloss units.

19. An acid etching composition comprising:
from 35 to 45 weight % of a bifluoride,
from 35 to 45 weight % of an inert filler,
from 15 to 25 weight % a sugar alcohol,
from 0.5 to 5 weight % of a thickener,
less than 5 weight % organic solvent, and
at least 20 weight % water.

20. The composition of claim 19, wherein the composition comprises less than 3 weight % of organic solvent.
